(19) United States
(12) Patent Application Publication
(10) Pub. No.: US 2017/0300892 A1
(43) Pub. Date: Oct. 19, 2017

(54) SETTLEMENT TERMINAL AND METHOD FOR STABLY PROVIDING PRIVILEGE SERVICE OF HOUSE CARD

(71) Applicant: TOSHIBA TEC KABUSHIKI KAISHA, Tokyo (JP)

(72) Inventor: Junpei Fukuda, Mishima (JP)

(21) Appl. No.: 15/098,575

(22) Filed: Apr. 14, 2016

(51) Int. Cl. G06Q 20/34; G06Q 30/02; G06Q 20/40

(52) U.S. Cl. CPC G06Q 20/34; G06Q 20/405; G06Q 30/0226

(57) ABSTRACT

In a settlement terminal of an embodiment, a payment amount receiving module receives input of a payment amount. An input receiving module receives input of type of card information for specifying type of a house card and member information for specifying a member of the house card. If no response to a credit inquiry is received from a settlement server, a settlement module applies a privilege provided to the member of the house card to the payment amount to execute a settlement processing with a payment method other than the house card. If communication with the settlement server becomes available, a transaction information output module outputs information indicating the content of a privilege applied by the settlement module when no response to the credit inquiry is received and the member information of the member who owns the house card to which the privilege is applied to the settlement server.

### FIELD

Embodiments described herein relate generally to a settlement terminal and a method for stably providing a privilege service of a house card.

### BACKGROUND

Conventionally, credit cards include a card which is called as a house card for use in a specific company or retail store group. The house card is used to enclose customers and enhance transactions (business) for the company or the store group. For example, the card member of a house card can receive services dedicated for, member, e.g., a providing of member points or a discount, every time the settlement is performed with his or her house card. In addition, there is also a case in which a service of increasing a point providing rate or a discount rate is set for a privilege period as a privilege service dedicated to a member. On the other hand, apart from the above-described business merits for the company or the store group issuing the house card, transaction histories which are collected at the time of settlement with the house card can be used for a marketing analysis of its business. A conventional technology relating to a sales registration data processing apparatus for carrying out a settlement processing with a house card is known.

There is a possibility of trouble in which malfunction of a server (settlement server) in a settlement center for managing the settlement processing of house card or interruption of the communication between a store (settlement terminal) and the settlement center (settlement server) occurs. If such a trouble occurs, the settlement terminal which carries out a settlement processing in the store cannot make a credit inquiry to the settlement server, and in this case a settlement processing with the house card cannot consequentially be performed in the store. Thus, in the past, the member having the house card cannot enjoy the foregoing member privileges if such a trouble occurs. Particularly, as most members prefer shopping in the foregoing privilege period, if the privilege service of the house card is unavailable for the privilege period, then there is an apprehension that the creditability of the house card is impaired. Thus, it is always desired that the privilege service of the house card can be stably provided even for a period for which a credit inquiry cannot be made.

### DESCRIPTION OF THE DRAWINGS

FIG. 1 is a schematic diagram illustrating the structure of a settlement system according to an embodiment;

FIG. 2 is a perspective view illustrating the appearance of a settlement terminal;

FIG. 3 is a block diagram illustrating the hardware structure of the settlement terminal;

FIG. 4 is a block diagram illustrating the functional structure of the settlement terminal;

FIG. 5 is a diagram exemplifying the data structure of a period-privilege storage section;

FIG. 6 is a diagram exemplifying the data structure of a discount information storage section;

FIG. 7 is a diagram exemplifying the data structure of a point information storage section;

FIG. 8 is a diagram exemplifying the data structure of an error-period transaction data;

FIG. 9 is a flowchart exemplifying the procedures of a settlement processing carried out by the settlement terminal; and

FIG. 10 is a flowchart exemplifying the procedures of an error-period transaction data sending processing carried out by the settlement terminal.

### DETAILED DESCRIPTION

In accordance with an embodiment, a settlement terminal comprises a payment amount receiving module, an input receiving module, a credit inquiry requesting module, a settlement module and a transaction information output module. The payment amount receiving module receives the input of a payment amount. The input receiving module receives the input of type of card information for determining the type of a house card and member information for determining the member of the house card. The credit inquiry requesting module sends the payment amount, the type of card information and the member information to a settlement server for the house card and sends a credit inquiry request to obtain a response relating to whether or not the payment amount can be settled with the house card of the member. If no response to the credit inquiry is received from the settlement server, then the settlement module applies a privilege provided to the member of the house card to the payment amount to execute a settlement processing with a payment method other than the house card. If the communication with the settlement server becomes available, the transaction information output module outputs information indicating the content of the privilege applied by the settlement module when no response to the credit inquiry is received and the member information of the member who owns the house card to which the privilege is applied to the settlement server for the house card.

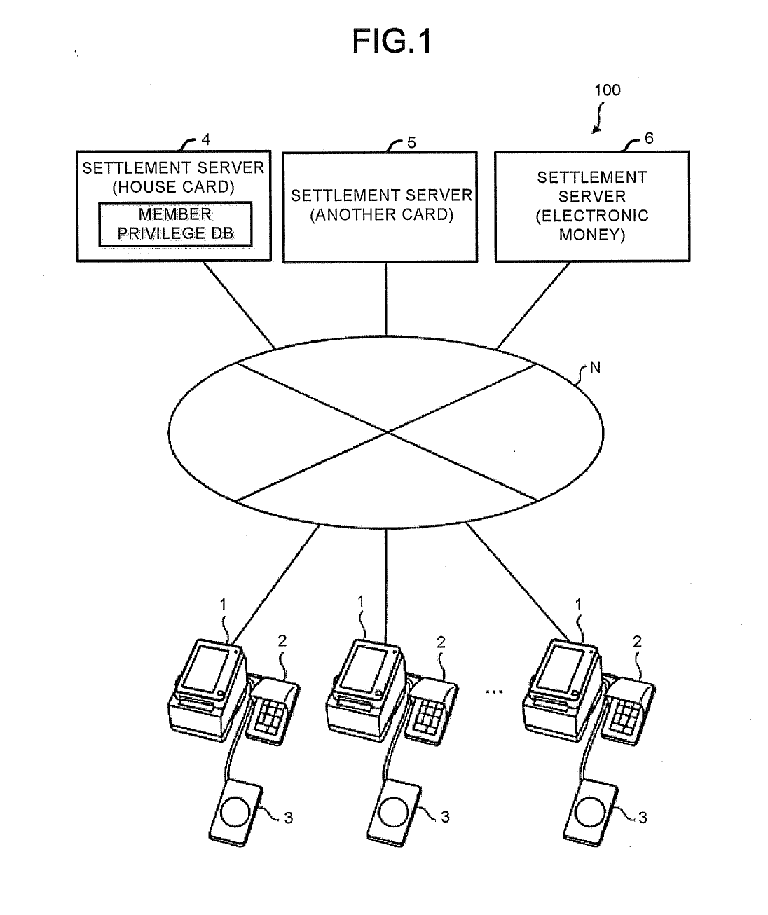

FIG. 1 is a schematic diagram illustrating the structure of a settlement system 100 according to the embodiment. The settlement system 100 comprises a settlement terminal 1 and a settlement server 4 for house card. The settlement terminal 1 is connected with the settlement server 4 through a wired or wireless network N. Further, in the settlement system 100, the settlement terminal 1 is connected with a PIN-pad (Personal Identification Number pad) terminal 2 and a reader 3. Additionally, no specific limitation is applied to the number of the settlement terminals 1 connected with the network N.

The PIN-pad terminal 2 is an input device which receives an input of a password when a settlement processing with a credit card is carried out through the settlement terminal 1. The PIN-pad terminal 2 is equipped with operation keys including a numeric keypad and a ‘determine’ key. The PIN-pad terminal 2 outputs the input information, for example, a password, received from the operation keys to the settlement terminal 1.

The reader 3 uses a short-distance wireless communication technology such as an NFC (Near Field Communication). The reader 3 reads, from a non-contact type IC card which electronically records money information, the information (electronic money information) relating to an electronic settlement.

Further, the PIN-pad terminal 2 or the reader 3 may be built in the settlement terminal 1. The settlement terminal 1 may further be connected with another device such as a POS (Point Of Sales) terminal to carry out a settlement processing in cooperation with the another device.

The settlement server 4 for house card is a server for managing the settlement processing of the house card. Further, the house card refers to a group card franchised to a store in which the settlement terminal 1 is installed. The settlement server 4 for house card stores settlement information (transaction data), received from the settlement terminal 1, which relates to the settlement with the house card in a settlement history database to manage the settlement information with the house card. Further, the settlement serer 4 for house card has a member privilege database (DB) 41 for storing information relating to a privilege provided to the member of the house card.

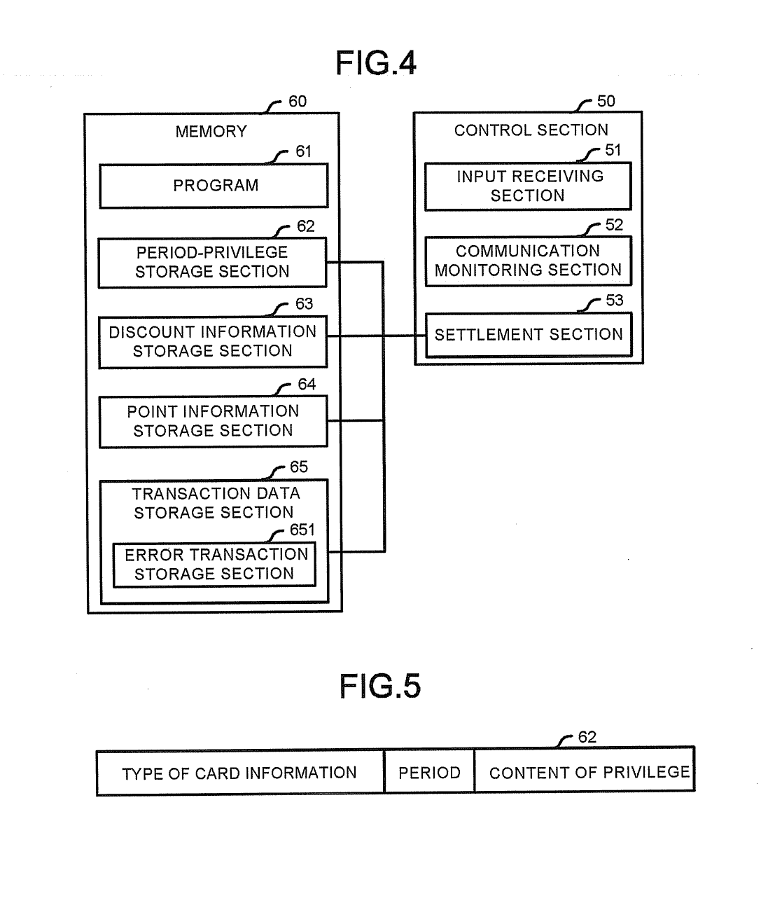

The member privilege DB 41 stores, for example, information relating to a privilege available for a specific period and a privilege available for a normal period. Information indicating a point providing rate corresponding to a payment amount or information indicating a discount rate applied to a member is stored as the privilege. The settlement terminal 1 accesses the member privilege DB 41 in the settlement server 4 to update the data stored in each database (a period-privilege storage section 62, a discount information storage section 63 and a point information storage section 64 shown in FIG. 4) in a memory 60 of the settlement terminal 1.

No specific limitation is applied to the timing at which settlement terminal 1 updates the data in each database. For example, a control section 50 (refer to FIG. 4) of the settlement terminal 1 may access the member privilege DB 41 at a specific timing within the business time or before the store opens to update data in the period-privilege storage section 62, the discount information storage section 63 and the point information storage section 64 (refer to FIG. 4).

A settlement server 5 for another card is used for managing a settlement processing with a credit card other than the house card. Actually, as the settlement server 5 is arranged for each credit company, a plurality of settlement servers 5 is connected with the network N. For the sake of simplicity, only one settlement server 5 responsible for the settlement with one kind of credit card is shown in FIG. 1. Although the customer desires to settle a transaction with his or her house card, in the case of the trouble of the communication between the settlement terminal 1 and the settlement server 4 for house card, the settlement terminal 1 can carryout a settlement processing with another credit card as a replacement settlement method. The settlement terminal 1 communicates, in a data transmission including settlement information, with the settlement server 5 for another card in the settlement processing.

A settlement server 6 for electronic money is used for carrying out a settlement processing with electronic money. Similar to the settlement server 5, the settlement server 6 is practically set for each kind of electronic money. Thus, though a plurality of settlement servers 6 is connected with the network N, for the sake of simplicity, only one settlement server 6 is exemplified in FIG. 1. Although the customer desires to settle a transaction with his or her house card, in the case of the trouble of the communication between the settlement terminal 1 and the settlement server 4 for house card, the settlement terminal 1 can carry out a settlement processing with electronic money as a replacement settlement method. The settlement terminal 1 communicates, in a data transmission including settlement information, with the settlement server 6 for electronic money in the settlement processing.

Next, the structure and the functions of the settlement terminal 1 are exemplified below.

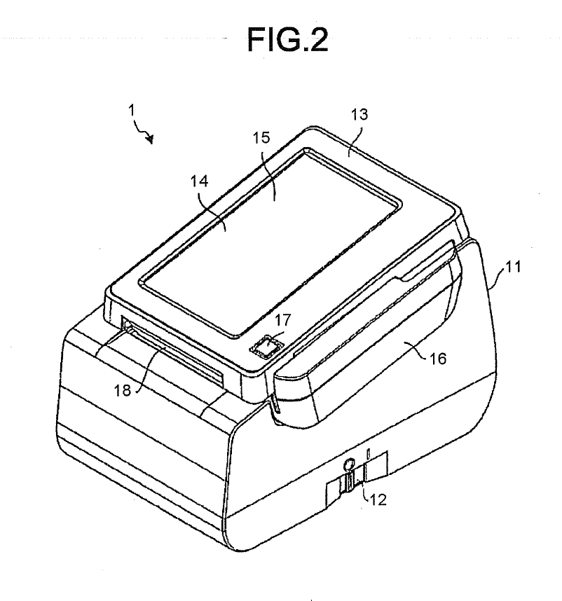

FIG. 2 is a perspective view illustrating the appearance of the settlement terminal 1. A power switch 12 is arranged at a side of a main body 11 of the settlement terminal 1. Further, a top panel 13 which can be opened and closed with respect to the main body 11 is arranged on the upper part of the main body 11. The top panel 13 is opened so that a rolled receipt paper can be placed in the main body 11. Further, a display section 15 having a touch panel serving as an operation section 14 on the surface thereof is arranged on the surface of the top panel 13.

A card reader 16 which reads magnetic information from a credit card is arranged on the right end part of the top panel 13. A reset button 17 is arranged between the display section 15 and the card reader 16 on the upper panel 13. The reset button 17 is an operation button for resetting the information input from the operation section 14 or the information read by the card reader 16.

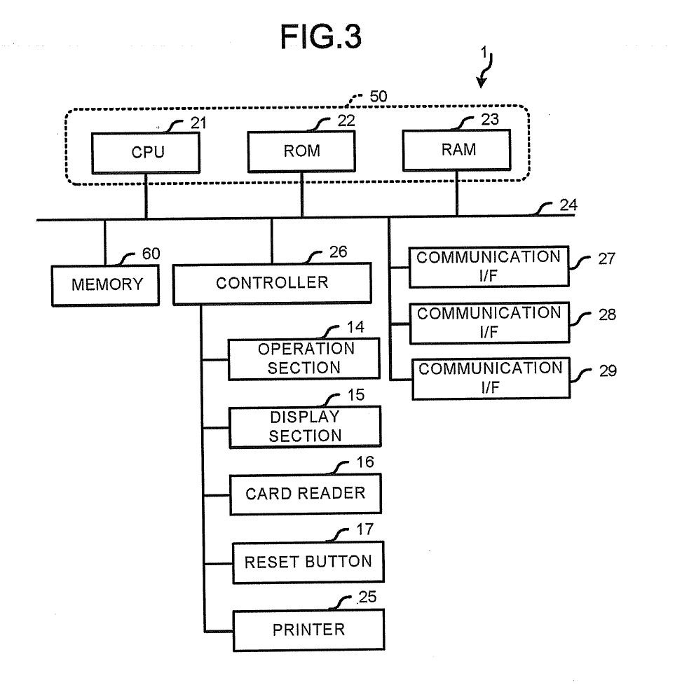

A printer 25 (refer to FIG. 3) is arranged in the main body 11 to print settlement-related information and a sales report on the foregoing receipt paper. The printed receipt paper is issued from a receipt issuing port 18 located between the main body 11 and the top panel 13.

FIG. 3 is a block diagram illustrating the hardware structure of the settlement terminal 1. As shown in FIG. 3, the settlement terminal 1 includes a control section 50 for controlling each section. The control section 50 is formed by connecting, via bus lines 24 including an address bus line and a data bus line, a ROM (Read Only Memory) 22 and a RAM (Random Access Memory) 23 with a CPU (Central Processing Unit) 21 for collectively controlling each section. The RAM 23 functions as a working area of the CPU 21.

The control section 50 is connected with the memory 60, a controller 26 and communication interfaces (I/F) 27, 28 and 29 via the bus lines 24. The memory 60, which is a non-volatile memory (e.g. flash memory) capable of holding storage information even if power is cut off, stores programs and various setting data. The data stored in the memory 60 is described later with reference to FIG. 4.

The controller 26 is connected with the operation section 14, the display section 15, the card reader 16 and the reset button 17 and the printer 25. The display section 15 displays operation keys, etc. The display section 15 displays a GUI (Graphical User Interface) for assisting in the various operations relating to a credit card settlement under the control of the control section 50. The display section 15 displays a software keyboard (operation keys) for inputting a payment amount or selecting a payment method (single payment or installment payment). The operation section 14 receives a touch operation on each of the operation keys displayed on the display section 15. The printer 25 controls a thermal head to print receipt data or error data on the receipt paper.

The communication I/F 27 is an interface for connecting the PIN-pad terminal 2. The communication I/F 28 is an interface for connecting the reader 3. The control section 50 carries out data communication with the PIN-pad terminal 2 via the communication I/F 27. The communication I/F 29 is an interface for connecting the settlement terminal 1 with the network N. The control section 50 carries out data communication with the settlement server 4 for house card, or the settlement server 5 for a credit card other than the house card or the settlement server 6 for electronic money via the communication I/F 29 and the network N.

FIG. 4 is a block diagram illustrating the functional structure of the settlement terminal 1. The memory 60 includes a program 61 which is executed by the settlement terminal 1 in a settlement processing, the period-privilege storage section 62, the discount information storage section 63, the point information storage section 64 and a transaction data storage section 65. The transaction data storage section 65 includes an error transaction storage section 651.

Further, the period-privilege storage section 62, the discount information storage section 63 and the point information storage section 64 may be stored in an external storage device different from the memory 60. Alternatively, as stated above, these databases may be stored in a POS terminal at the time the POS terminal is connected with the settlement terminal 1. Then, the settlement terminal 1 accesses these databases from the external storage device or the POS terminal to read various kinds of privilege-related information.

FIG. 5 is a diagram exemplifying the data structure of the period-privilege storage section 62. The period-privilege storage section 62 is a data file which stores the content of a premium privilege available for a privilege increasing period within which the privilege is increased in comparison with that in a normal period. As shown in FIG. 5, in the period-privilege storage section 62, a ‘ type of card information’, a ‘period’ within which the premium privilege is set and a ‘content of premium privilege’ are set in an association manner. The ‘type of card information’ is information for specifying the type of a house card. The ‘content of premium privilege’ is information indicating the content of the premium privilege provided to the member of, a house card specified by the ‘type of card information’ for the privilege increasing period set by the ‘period’. Information indicating a discount rate, a point providing rate and the like is set in the ‘content of premium privilege’.

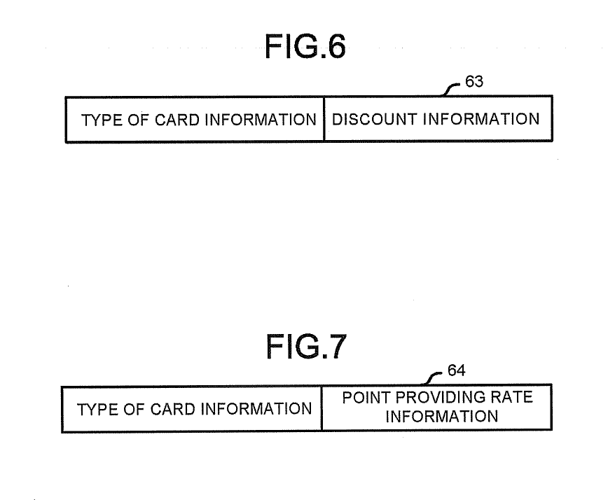

FIG. 6 is a diagram exemplifying the data structure of the discount information storage section 63. The discount information storage section 63 is a data file which stores the discount rate applied to the member of a house card for a normal period. As shown in FIG. 6, in the discount information storage section 63, the ‘type of card information’ and a ‘discount information’ which indicates a discount rate applied to the member of a house card are stored in an association manner.

FIG. 7 is a diagram exemplifying the data structure of the point information storage section 64. The point information storage section 64 is a data file which stores a point providing rate (also called as a point return rate) applied to the member of a house card according to a payment amount. As shown in FIG. 7, in the point information storage section 64, the ‘type of card information’ and a ‘point providing rate information’ which indicates a point providing rate applied to the member of a house card are stored in an association manner.

Return to FIG. 4, the transaction data storage section 65 is a memory area in which the settlement information (transaction data) of each transaction settled by the settlement terminal 1 is stored. Information relating to a settlement with a house card, information relating to a settlement with a credit card other than the house card, information relating to a settlement with electronic money, information relating to a cash settlement and information relating to an error are stored in the settlement terminal 1 as a transaction data.

The settlement terminal 1 stores a record area for the transaction data generated in the case of a communication error and a record area for the transaction data generated in a normal case separately to distinguish the two kinds of transaction data from one the other. The normal case refers to a case in which a data communication is carried out normally between the settlement terminal 1 and the settlement server 4 for house card. In the normal case, the settlement terminal 1 carries out the data communication with the settlement server 4 to complete a settlement processing with a house card. On the other hand, the case of a communication error refers to a case in which a settlement processing with a house card cannot be carried out because of the occurrence a data communication error between the settlement terminal 1 and the settlement server 4 for house card. In the latter case, the settlement terminal 1 carries out a settlement processing with other payment method substituted for the house card, e.g., other credit card, electronic money or cash.

Further, in a settlement processing with these substitute payment methods, the settlement terminal 1 applies a privilege provided to the member of the house card to a payment amount for the transaction and then carries out the settlement processing. Moreover, the settlement terminal 1 generates settlement information relating to the settlement with the substitute payment method and the transaction data at the time of the occurrence of error (transaction data at error) including information indicating the content of the privilege temporarily provided to the member with the substitute payment method and stores the transaction data in the error transaction storage section 651. Then, if the communication between the settlement terminal 1 and the settlement server 4 is restored, the settlement terminal 1 sends the data stored in the error transaction storage section 651 to the settlement server 4.

Further, the transaction data storage section 65 records a series of operation logs from the beginning to the end. The transaction data storage section 65 records, without any omission, the transaction data generated in the normal case and that (transaction data at error) generated when the settlement processing with the substitute payment method is carried out at the time the communication between the settlement terminal 1 and the settlement server 4 is failed. Moreover, the settlement terminal 1 stores the transaction data at error in the error transaction storage section 651 so that the transaction data at error can be sent to the settlement server 4 quickly when the communication with the settlement server 4 is restored.

Further, in FIG. 4, the transaction data at error is stored in the error transaction storage section 651 different from a storage area for storing the transaction data generated in the normal case in the transaction data storage section 65. However, the error transaction storage section 651 may not be arranged specially. If the control section 50 of the settlement terminal 1 has a function of extracting the transaction data at error from a series of transaction data, then a memory area of the error transaction storage section 651 is not needed.

Next, the program 61 executed by the settlement terminal 1 in a settlement processing is described below. The program 61 executed by the settlement terminal 1 of the present embodiment is incorporated into the memory 60 in advance. The program 61 executed by the settlement terminal 1 of the present embodiment may be recorded in a computer-readable recording medium such as a CD-ROM, a FD (Flexible Disk), a CD-R, and a DVD (Digital Versatile Disk) in the form of installable or executable file.

Further, the program 61 executed by the settlement terminal 1 of the present embodiment may be stored on a computer connected with a network such as an Internet and downloaded via the network to be provided. Alternatively, the program 61 executed by the settlement terminal 1 of the present embodiment may be provided or distributed by a network such as the Internet.

As shown in FIG. 4, the program 61 executed by the settlement terminal 1 of the present embodiment is a module structure including an input receiving section 51, a communication monitoring section 52 and a settlement section 53. The CPU 21 (processor) reads out the program 61 from the memory 60 and copies or decompresses the program 61 on the RAM 23 to load the foregoing sections on a main storage device to generate the input receiving section 51, the communication monitoring section 52 and the settlement section 53 on the main storage device.

The input receiving section 51 receives various kinds of information input from the operation section 14, the card reader 16, the PIN-pad terminal 2 and the reader 3.

For example, the input receiving section 51 receives the magnetic information read by the card reader 16 from a credit card. The magnetic information of a credit card includes type of card information for specifying the type of the credit card and member information. The member information refers to information for specifying the owner (member) of the credit card, e.g., a name of card holder, a card number and the like. If a credit card is a house card, then the type of card information is used for specifying the type of the house card, and the member information is used for specifying the member of the house card.

Further, if the operation section 14 receives a touch operation on an operation key, then the input receiving section 51 receives input of information corresponding to the operation key. In this way, the input receiving section 51 receives the input of a payment amount and a payment method which refers to a manner of payment (number of installment payments) for credit card settlement, for example, a single payment and an installment payment. Further, if a cash settlement mode or an electronic money settlement mode is selected with the operation key if a settlement cannot be carried out with a house card, then the input receiving section 51 receives the substitute settlement method as information indicating a payment method.

Further, the input receiving section 51 receives input information corresponding to a key operated on the PIN-pad terminal 2. Further, the input receiving section 51 reads electronic money information, for example, an electronic money ID, read through the reader 3 from an IC card.

The communication monitoring section 52 monitors the state of the communication between the settlement terminal 1 and the settlement server 4. If the connection between the settlement terminal 1 and the settlement server 4 is cut off, then the communication monitoring section 52 notifies the settlement section 53 of the occurrence of the communication error. Further, by continuously monitoring the state of the communication between the settlement terminal 1 and the settlement server 4 as well after the communication error occurs, the communication monitoring section 52 notifies the settlement section 53 of the state in which communication between the settlement terminal 1 and the settlement server 4 can be performed if the connection between the settlement terminal 1 and the settlement server 4 is restored.

The settlement section 53 controls the settlement processing with various payment media such as a settlement with a house card, a settlement with a credit card other than the house card, a settlement with electronic money, and a cash settlement. Further, at the time of the settlement with a house card, the settlement section 53 carries out a privilege providing processing in which a privilege is provided to the member of the house card. Further, the settlement section 53 requests the settlement server 4 for house card to make a credit inquiry which requests a response to the inquiry whether or not the payment amount received by the input receiving section 51 can be settled with the use of the house card received by the input receiving section 51.

Privilege Providing Processing:

The settlement section 53 reads, from the period-privilege storage section 62, the discount information storage section 63 and the point information storage section 64 of the memory 60, information relating to a privilege of a house card specified by the type of card information received by the input receiving section 51. If a privilege applied on the current date is set in the period-privilege storage section 62, then the settlement section 53 gives a priority to the privilege stored in the period-privilege storage section 62 and provides it to the member. If no privileges applied on the current date are set in the period-privilege storage section 62, then the settlement section 53 respectively provides the privilege stored in the discount information storage section 63 and that stored in the point information storage section 64.

The settlement section 53 applies the read privilege to the payment amount received by the input receiving section 51 to carry out a settlement processing. If a discount is applied as a privilege, then the settlement section 53 calculates a discounted payment amount according to the payment amount and a discount rate. The settlement section 53 settles the discounted payment amount with the use of another payment method received by the input receiving section 51. Further, if point providing is applied as a privilege, then the settlement section 53 calculates points added corresponding to the current transaction according to the payment amount and a point providing rate.

Request for Credit Inquiry:

The settlement section 53 generates inquiry information including a settlement date and time, a store name, information of person in charge, type of card information, member information, a payment amount, a payment method and the content of a privilege to send the generated inquiry information to the settlement server 4. Then, the settlement section 53 sends a request for credit inquiry to the settlement server 4 to request the processing of the credit inquiry on the settlement information sent to the settlement server 4. The credit inquiry refers to a process that the settlement server 4 determines whether or not the inquired payment amount can be settled with the credit card of the member (inquiry target) and sends the result of the determination (the result of the credit inquiry) to the settlement terminal 1 as a response.

If the member is put on a blacklist for the reason of delay of the payment or the like, then the settlement server 4 sends an inquiry result indicating that the settlement with the credit card cannot be accepted to the settlement terminal 1 as a response. On the other hand, if a condition for executing the settlement with the credit card is cleared, then the settlement server 4 sends an inquiry result indicating that the inquiry content can be settled to the settlement terminal 1 as a response to accept the settlement request. The condition for executing the settlement refers to, for example, no delay of payment, a member who is permitted to pay with a credit card, a total payment amount of the month being below a limited payment amount. The settlement section 53 of the settlement terminal 1 receives the inquiry result sent from the settlement server 4.

Settlement Processing in a Normal Connection Period:

If an inquiry result indicating that a settlement with a credit card is accepted is received from the settlement server 4, then the settlement section 53 records information indicating that the request for the settlement of the transaction is accepted and generates a transaction data (normal data). The transaction data generated in a normal condition includes information identical to the inquiry information sent to the settlement server 4 and information indicating that settlement of the transaction is accepted. The settlement section 53 stores the transaction data generated in the normal condition in the transaction data storage section 65.

Settlement Processing in a Connection Error Period:

On the other hand, if no inquiry result is received by the settlement section 53 from the settlement server 4, in other words, a communication error is notified by the communication monitoring section 52, then the settlement section 53 cannot send a transaction data to the settlement server 4. In this case, the settlement section 53 applies a privilege for member of the house card to a settlement processing of the transaction and carries out the settlement processing with another payment method but not with the house card. If a discount service is applied as a privilege for member as stated above, then the settlement section 53 calculates a payment amount to which the discount for member is applied to determine it as a payment amount to be paid with another settlement medium. Further, the settlement section 53 generates a transaction data in error state including a record of the occurrence of an error and information indicating the content of the privilege applied to the member of the house card.

Example of Structure of a Transaction Data in a Connection Error Period:

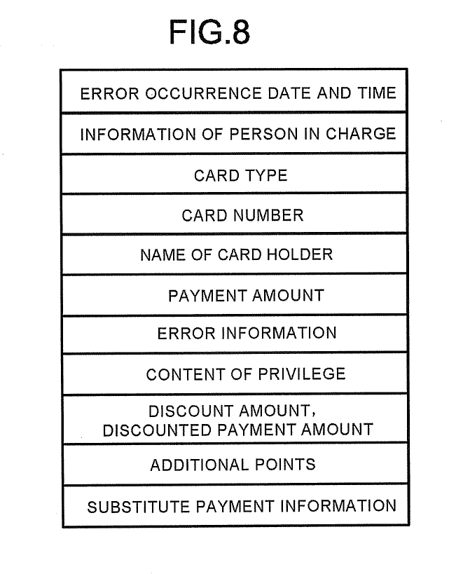

FIG. 8 is a schematic diagram exemplifying the data structure of the transaction data in the connection error period. As shown in FIG. 8, the transaction data in the connection error period includes a date and time on which the error occurs. Further, the transaction data in the connection error period includes information of person in charge who operates the operation section 14 at the time the input receiving section 51 receives an input from the operation section 14. The information of person in charge indicates a store clerk who carries out the settlement processing. Further, the transaction data in the connection error period includes the type of the card, the card number and the name of house card holder that are received by the input receiving section 51 through the card reader 16. Further, the transaction data in the connection error period includes a payment amount received by the input receiving section 51.

Further, the transaction data in the connection error period includes error information indicating an error status. The error information may include an error number corresponding to the error status or text data indicating the error status. For example, information indicating that an error occurs in the communication with the settlement server 4 is used as the error information.

Moreover, the transaction data in the connection error period includes information indicating the content of the privilege applied in substitution to the member of the house card by the settlement terminal 1 instead of the settlement server 4 for house card when the error occurs. As an example, the content of the privilege is ‘privilege applied to AAA card: a 5% discount’ or ‘AAA card: double points: XX points’. Further, if a discount for member is applied as a privilege, then the transaction data in error period includes a discount amount and a payment amount after the discount is applied, as shown in FIG. 8. Further, if points are added as a privilege, then the transaction data in error period includes points added, as shown in FIG. 8.

Further, the transaction data in error period is generated such that the ‘substitute payment information’ is included in the transaction data in error period as information relating to a payment method with which the final payment of a bill is carried out in place of the house card. If a settlement is finally carried out with cash, the settlement section 53 sets information indicating that the settlement with cash is executed as a substitute payment information. If a settlement is finally carried out with electronic money, then the settlement section 53 sets information indicating that the settlement with electronic money is executed as a substitute payment information.

Further, if a settlement is finally carried out with a credit card other than the house card, then the settlement section 53 sets information indicating the type of the card, the card number, the name of the card holder and the payment method (number of divided payments) of the credit card used for the settlement processing as substitute payment information. Further, the settlement section 53 makes a credit inquiry to the settlement server 5 for the credit card as usual at the time the settlement processing with a credit card other than the house card is carried out. The details of the processing of the credit inquiry can be known from the prior art and are therefore not described herein.

Transaction Sending Processing after the Connection is Restored:

If the restoration of the connection between the settlement terminal 1 and the settlement server 4 is detected by the communication monitoring section 52, the settlement terminal 53 sends the transaction data in error period stored in the error transaction storage section 651 to the settlement server 4 for house card.

The settlement server 4 carries out a processing for compensating an expenses (discount amount) to the store, the card issuing company or the company that operates electronic money settlement service which actually bears the expenses according to the transaction data in error period received from the settlement terminal 1. As stated above, the transaction data in error period includes a discount amount and substitute payment information as shown in FIG. 8, and thus, the company that operates the settlement service of the house card can get information indicating the company that actually bears the discount amount and an amount to be compensated easily. As a result, the company that operates the settlement service of the house card can smoothly and practically carry out the compensation processing for the discount amount for the company that actually bears the discount amount in place of the company that operates the settlement service of the house card.

Further, the settlement server 4 updates the points of the member managed by a member master file (not shown) with the use of the points added contained in the transaction data in error period. As shown in FIG. 8, the transaction data in error period includes member information and points added, and thus, the settlement server 4 can carry out an update processing of points smoothly after the connection is restored.

The operation procedures of the program 61 are described below.

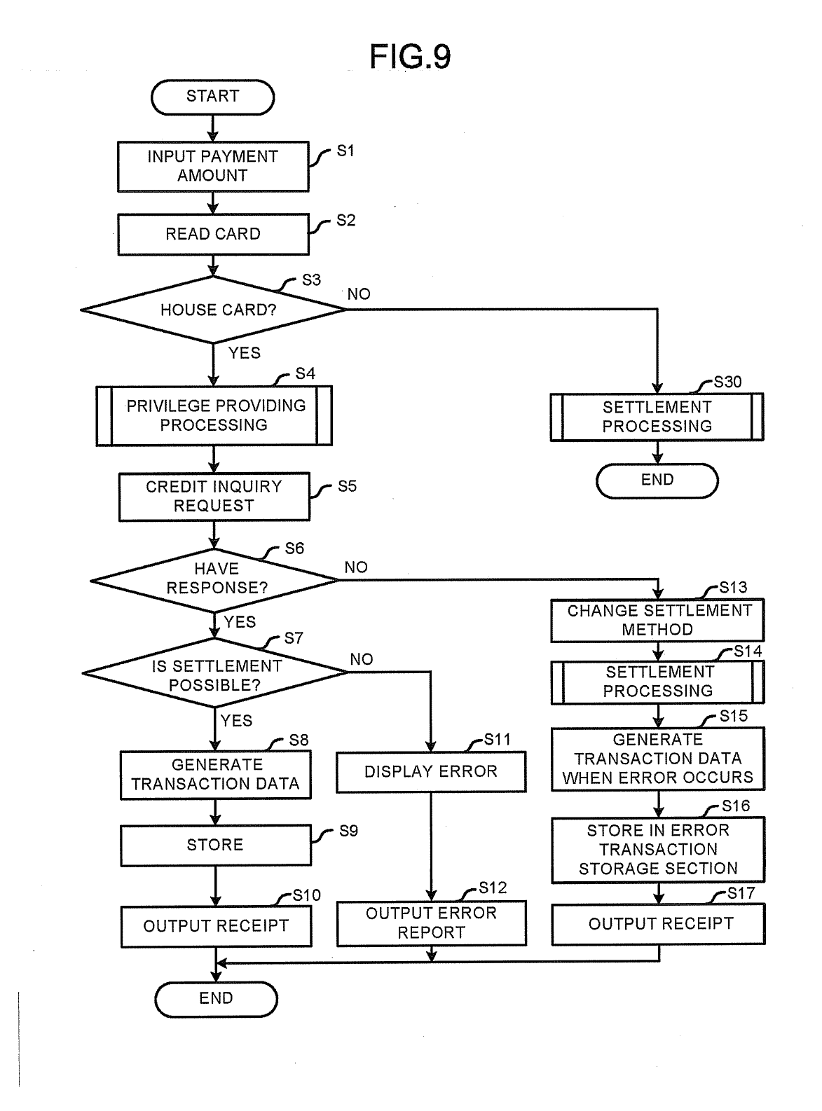

FIG. 9 is a flowchart exemplifying the procedures of a settlement processing carried out by the settlement terminal 1. The input receiving section 51 receives, via the operation section 14, a payment amount input for a transaction (Act S1). Then, if the magnetic information of a credit card is read by the card reader 16, then the input receiving section 51 receives the input of the card information, for example, the type of card information, the card number and the name of card holder, contained in the magnetic information (Act S2).

The settlement section 53 determines whether or not the credit card used for the settlement processing is a house card according to the card information read in Act S2 (Act S3). If the credit card used for the settlement processing is not a house card (Act S3: No), the settlement section 53 carries out a settlement processing with a normal credit card (Act S30). The settlement section 53 generates inquiry information indicating the content of the transaction to make a credit inquiry to the settlement server 5 of the credit card issuing company indicated by the type of the card, without applying a discount for the member of a house card to the payment amount or providing a member points as well. Then, if a response indicating that a settlement can be carried out is received from the settlement server 5 as the result of the credit inquiry, then the transaction data of the approval of the settlement is generated and stored in the transaction data storage section 65, and then the processing is ended.

If the credit card used for the settlement processing is a house card (Act S3: Yes), the settlement section 53 carries out a privilege providing processing (Act S4). If a discount rate is set in the period-privilege storage section 62 as a privilege for a period including the current date, then the settlement section 53 calculates a discount amount and a payment amount after the discount is applied based on the discount rate. If no period-privilege including the current date is set in the period-privilege storage section 62, then the settlement section 53 reads a discount rate from the discount information storage section 63. Then, the settlement section 53 calculates a price after the discount is applied to the payment amount received in Act S1 according to the read discount rate to update the payment amount. Further, the settlement section 53 displays the actual payment amount after the discount is applied on the display section 15.

Further, the settlement section 53 calculates points added as described above. If a point providing rate is set in the period-privilege storage section 62 as a period privilege corresponding to the current date, then the settlement section 53 calculates points added according to the point providing rate and the payment amount. If a point providing rate that is applied to the current date is not set in the period-privilege storage section 62, then the settlement section 53 reads a point providing rate from the point information storage section 64. Then, the settlement section 53 calculates points added according to the read point providing rate and the payment amount (Act S4).

Then, the settlement section 53 sends a request for credit inquiry to the settlement server 4 (Act S5). The settlement section 53 generates inquiry information including settlement date and time, a store name, information of person in charge, type of card information, member information, a total amount before a discount is applied, a discount amount, a payment amount after a discount is applied, a payment method (single payment or installment payment) and points added to send the generated inquiry information to the settlement server 4.

If a response to the credit inquiry is sent from the settlement server 4 (Act S6: Yes), then the processing in Act S7 is executed. If no response to the credit inquiry is sent from the settlement server 4 (Act S6: No), then the processing in Act S13 is executed. If a response indicating that a settlement is approved is contained in a credit inquiry result received from the settlement server 4 (Act S7: Yes), then the processing in Act S8 is executed. If a response indicating that the settlement of the payment amount with the credit card to which the credit inquiry is carried out is not approved is received (Act S7: No), then the processing in Act S11 is executed.

In Act S8, the settlement section 53 generates a transaction data of the approval of the settlement in such a process that information indicating that the content of the settlement of which the credit inquiry is made is accepted is added to the inquiry information generated in Act S5. The transaction data includes a settlement date and time, a store name, information of person in charge, a type of card information, member information, total amount before discount is applied, a discount amount, a payment amount after discount is applied, a payment method and points added. Then, the settlement section 53 stores the generated transaction data in the transaction data storage section 65 (Act S9). Further, the settlement section 53 generates a receipt data including the settlement date and time, the store name, the information of person in charge, the type of card information, the member information, the total amount before discount is applied, the discount amount, the payment amount after discount is applied and the payment method. The settlement section 53 outputs the receipt data to the printer 25 to print out a receipt (Act S10).

If a settlement is not approved (Act S7: No) according to the result of the credit inquiry, the settlement section 53 displays, on the display section 15, error information in which a determination result indicating that a payment cannot be carried out with the card is contained (Act S11). Further, the settlement section 53 prints out an error report containing the response result of the credit inquiry via the printer 25 (Act S12). In this case, the customer settles the transaction with another settlement method but not with the house card.

On the other hand, if no response is received from the settlement server 4 in Act S6 (Act S6: No), then the settlement section 53 displays information indicating an error in the connection with the settlement server 4 on the display section 15 to notify the connection error. The input receiving section 51 receives change of the settlement method through the operation section 14 (Act S13). The customer proffers to settle the transaction with one of cash, another credit card and electronic money as a substitute for the house card.

The settlement section 53 of the settlement terminal 1 carries out a settlement processing with the settlement method the user desires to use (Act S14). In this case, the settlement section 53 sets the payment amount after a member privilege is applied in Act S4 as a payment amount to be paid with the use of the substitute settlement method. For example, if a credit card other than the house card is used as a substitute settlement method for settlement, then the input receiving section 51 receives the input of the card information of the credit card. Moreover, the settlement section 53 includes the payment amount after a discount for member of the house card is applied and the card information of the credit card in inquiry information and sends the inquiry information to the settlement server 5 for another credit card. If a response indicating that the settlement is approved is sent from the settlement server 5 as the result of the credit inquiry, then the settlement section 53 generates transaction data relating to the settlement with the substitute payment method to store the generated transaction data in the transaction data storage section 65 as transaction data at the normal state (Act S14).

Then, the settlement section 53 carries out a processing for generating a transaction data for the error period. The settlement section 53 generates the transaction data for the error period including information relating to the house card, the content of the error occurring at the time transaction with the house card is carried out and information relating to the substitute payment method (Act S15). As shown in FIG. 8, the transaction data for an error period includes the card information of the house card, the content of the privilege of the house card, the discount amount, the payment amount after the discount is applied, the points added, the substitute payment information and the like.

The settlement section 53 stores the generated transaction data for the error period in the error transaction storage section 651 (Act S16). Further, the settlement section 53 generates a receipt data indicating the content of the transaction to print a receipt through the printer 25 (S17).

Example of Printing of a Receipt:

The settlement section 53 generates a receipt data including the settlement date and time, the store name, the information of person in charge, the card information of the credit card used for the settlement as a substitute for the house card, the total amount before the discount is applied, the discount amount, the payment amount after the discount is applied, the payment method and the points added to the house card. Further, in addition to the card information of the credit card finally used for the settlement, the receipt data may further include the card information of the house card (card number or member number). Further, information indicating a period for which a period-privilege is applied and the content of the privilege, an advertisement including a period-privilege may be included as information indicating a privilege applied, and the preannouncement of a next privilege period may also be included in the receipt data. The generation of such a receipt data is realized in such a way that the settlement section 53 reads information relating to the period-privilege from the period-privilege storage section 62 and inserts the read information in the receipt data as a print data.

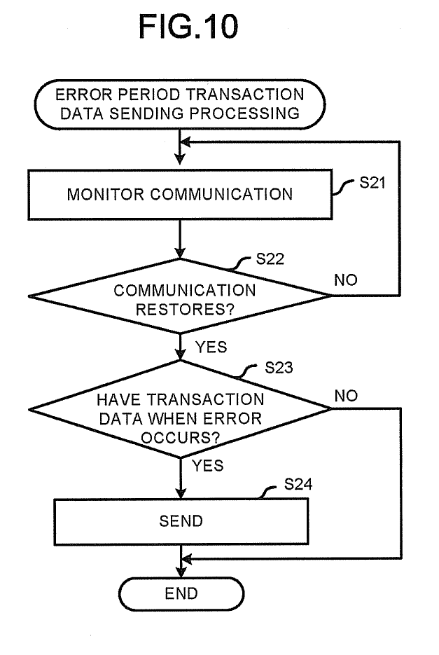

Then, the procedures carried out by the settlement terminal 1 to send the transaction data for an error period to the error transaction storage section 651 after the restoration of communication are exemplified below with reference to FIG. 10. FIG. 10 is a flowchart exemplified the procedures carried out by the settlement terminal 1 to send the transaction data for an error period.

The communication monitoring section 52 monitors the state of the communication between the settlement terminal 1 and the settlement server 4 after the occurrence of a connection error (Act S21). Then, the communication monitoring section 52 determines whether or not the communication between the settlement terminal 1 and the settlement server 4 is restored (Act S22). If the communication is not restored (Act S22: No), the flow returns to the processing in Act S21.

If the communication is restored (Act S22: Yes), the settlement section 53 determines whether or not a transaction data for the error period is stored in the error transaction storage section 651 (Act S23). If the transaction data for the error period is stored in the error transaction storage section 651 (Act S23: Yes), the settlement section 53 sends the transaction data for the error period stored in the error transaction storage section 651 to the settlement server 4 (Act S24). If no transaction data for the error period is stored in the error transaction storage section 651 (Act S23: No), then the flow of the processing is ended.

As stated above, if no response result to the credit inquiry is received from the settlement server 4, the settlement terminal 1 according to the present embodiment applies a privilege which is provided to the member of the house card and then carries out a settlement processing with another payment method but not with the house card. In this way, the member of a house card can enjoy the privilege service of a house card in the settlement for commodity even if a credit inquiry cannot be made because of the failure of the settlement server 4. Further, if the communication with the settlement server 4 becomes available, the settlement terminal 1 outputs information indicating the content of the privilege provided to the member when no response to the credit inquiry is received to the settlement server 4 for house card. In this way, the provider of the settlement service of the house card can smoothly carry out a post-processing, for example, an expense processing for clearing a compensation amount to the company which actually bears the discount amount in place of the provider and a point update processing.

Thus, the settlement terminal according to the present embodiment can stably provide a privilege service of a house card even if a problem occurs, for example, a credit inquiry of the house card cannot be made.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, according to the foregoing embodiment, the settlement section 53 carries out a privilege providing processing with reference to the databases in the memory 60 prior to the execution of a credit inquiry. However, the content of the privilege may be inquired to the settlement server 4 for house card each time as needed at a normal state at which the connection with the settlement server 4 can be made. For example, the settlement server 4 for house card refers to the member privilege DB 41 at the time of a credit inquiry to apply a member privilege to the content of the settlement. If the privilege is a discount service, then a payment amount after the discount is applied is calculated according to a payment amount and a discount rate and the settlement of the payment amount is accepted. Further, if points are provided as a privilege for member, then the number of points added is calculated according to a payment amount and a point providing rate, and the accumulated points stored in the member master file (not shown) is updated according to the points added. Then, the settlement server 4 sends the payment amount after the discount is applied, the points added and the updated accumulated points to the settlement terminal 1. The settlement section 53 of the settlement terminal 1 generates a transaction data with the use of the data received from the settlement server 4.

What is claimed is:

1. A settlement terminal, comprising:
a payment amount receiving module configured to receive the input of a payment amount;
an input receiving module configured to receive the input of a type of card information for specifying the type of a house card and a member information for specifying a member of the house card;
a credit inquiry requesting module configured to send the payment amount, the type of card information and the member information to a settlement server for the house card and send a request for a credit inquiry to obtain a response relating to whether or not the payment amount can be settled with the house card of the member;
a settlement module configured to execute a settlement processing with a payment method other than with the house card after a privilege provided to the member of the house card is applied to the payment amount if no response to the credit inquiry is received from the settlement server; and
a transaction information output module configured to output information indicating the content of the privilege applied by the settlement module at the time no response to the credit inquiry is received and the member information of the member who owns the house card to which the privilege is applied to the settlement server for the house card if the transaction information output module is capable of communicating with the settlement server.

2. The settlement terminal according to claim 1, further comprising
a monitoring module configured to monitor the state of the communication with the settlement server for house card, wherein the transaction information output module outputs the information indicating the content of the privilege and the member information to the settlement server if the monitoring module detects that the communication with the settlement server is available.

3. The settlement terminal according to claim 1, further comprising
a first reading module configured to read, from a first storage module in which a discount rate applied as the privilege to the member of the house card is stored, the discount rate applied to the member who owns the house card specified according to the type of card information received by the input receiving module, wherein the settlement module calculates a discount amount by applying the discount rate read by the first reading module to the payment amount received by the payment amount receiving module to settle the calculated discount amount with a payment method but not with the house card and the transaction information output module outputs the discount amount calculated by the settlement module and the member information of the member who enjoys the discount to the settlement server for house card if the communication with the settlement server becomes available.

4. The settlement terminal according to claim 2, further comprising
a first reading module configured to read, from a first storage module in which a discount rate applied as the privilege to the member of the house card is stored, the discount rate applied to the member who owns the house card specified according to the type of card information received by the input receiving module, wherein the settlement module calculates a discount amount by applying the discount rate read by the first reading module to the payment amount received by the payment amount receiving module to settle the calculated discount amount with a payment method but not with the house card and the transaction information output module outputs the discount amount calculated by the settlement module and the member information of the member who enjoys the discount to the settlement server for house card if the communication with the settlement server becomes available.

5. The settlement terminal according to claim 1, further comprising
a second reading module configured to read, from a second storage module in which a point providing rate that is provided to the member of the house card as the privilege according to the payment amount is stored, the point providing rate applied to the member who owns the house card specified according to the type of card information received by the input receiving module, wherein the settlement module calculates points provided to the member of the house card according to the payment amount received by the payment amount receiving module and the point providing rate read by the second reading module and the transaction information output module outputs the points calculated by the settlement module and the member information of the member who owns the card to which the points are provided to the settlement server for house card if the communication with the settlement server becomes available.

6. The settlement terminal according to claim 1, further comprising
a period-privilege reading module configured to read, according to a period-privilege storage module in which a privilege increasing period for which a privilege service is increased in comparison with that for a normal period and the content of a privilege applied to the member of the house card within the privilege increasing period are stored in an association manner, a privilege applied for the privilege increasing period from the period-privilege storage module if the current date is within the privilege increasing period, wherein the settlement module carries out the settlement processing with a payment method but not with the house card by applying, if the privilege read by the period-privilege reading module is available for the current date, the privilege to the payment amount.

7. A method for stably providing a privilege service for a house card by a settlement terminal, including:
receiving input of a payment amount;
receiving input of type of card information for specifying the type of a house card and member information for specifying member of the house card;
sending the payment amount, the type of card information and the member information to a settlement server for the house card;
sending a request for a credit inquiry to obtain a response relating to whether or not the payment amount can be settled with the house card of the member;
executing a settlement processing with a payment method other than with the house card after a privilege provided to the member of the house card is applied to the payment amount, if no response to the credit inquiry is received from the settlement server; and
outputting information indicating the content of the privilege applied at the time no response to the credit inquiry is received and the member information of the member who owns the house card to which the privilege is applied to the settlement server for the house card if communication with the settlement server becomes available.
